(19) United States
(12) Patent Application Publication
(10) Pub. No.: US 2006/0232149 A1
(43) Pub. Date: Oct. 19, 2006

(54) Balancing structure for motor

(75) Inventors: Alex Horng, Kaohsiung (TW); Yin-Rong Hong, Kaohsiung (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung (TW)

(21) Appl. No.: 11/157,841

(22) Filed: Jun. 22, 2005

(30) Foreign Application Priority Data
Apr. 18, 2005 (TW) 94112317

(51) Int. Cl. H02K 11/00; H02K 23/66

(52) U.S. Cl. 310/68 B

(57) ABSTRACT

A motor includes a fixed portion, a rotor, and a balancing plate. The fixed portion includes a stator having at least one winding and a plurality of pole faces. The rotor includes an annular magnet facing the pole faces of the stator and a shaft rotatably extending through the fixed portion. The balancing plate is mounted on the fixed portion and includes a connecting portion and at least two magnetically conductive faces that are integrally formed with the connecting portion as a single member and that face at least one face of the annular magnet. The at least two magnetically conductive faces are supported and connected by the connecting portion of the balancing plate. The at least two magnetically conductive faces and the annular magnet provide a magnetically attracting balancing effect for the rotor.

### BACKGROUND OF THE INVENTION

1. Field of the Invention

The present invention relates to a balancing structure for a motor. In particular, the present invention relates to a balancing structure for maintaining stable rotation of a rotor of a motor.

2. Description of Related Art

A wide variety of structures for maintaining rotational balance for a rotor of a motor have been proposed. One of these structures comprises a fixed portion, a rotor, an attracting portion, and a magnetically conductive portion. The fixed portion includes a base, an axial tube fixed on the base, a bearing received in the axial tube, a stator, and a circuit board. The stator includes a coil with axial winding or radial winding and a plurality of pole plates (or pole arms). The rotor includes a shaft rotatably extending through the bearing and an annular magnet surrounding the pole faces of the pole plates. The attracting portion is provided on a bottom of the rotor or a top end of the axial tube. Alternatively, the attracting portion is provided by the annular magnet or the alternating magnetic fields created by the pole plates of the stator. The magnetically conductive portion is made of a magnetically conductive material and may be comprised of a disc with two arcuate edges, a casing fixed in a rotor housing of the rotor, an annular plate, a plurality of arcuate plates, or a rotor housing of a spindle motor. The magnetically conductive portion may be provided on the circuit board, an inner periphery of the rotor, or the bottom of the rotor, and associated with the attracting portion. Such a structure is disclosed in, e.g., Taiwan Utility Model Publication Nos. 383818, 422365, 428838 and M241969, U.S. Pat. Nos. 6,097,120; 6,483,209; 6,700,241; and 6,727,626, and U.S. Patent Publication No. 2005/0006962.

When the motor turns, alternating magnetic fields are created by the pole faces of the magnetic pole plates (or pole arms). The magnetically conductive portion is attracted by the attracting portion during rotation of the rotor, thereby maintaining rotational balance of the rotor, avoiding disengagement of the rotor shaft from the stator, reducing rotational friction of the bearing, and prolonging the life of the motor.

It is common to make the size of the metal plate consisting of the magnetically conductive portion as large as possible so as to provide a large area facing the magnet of the attracting portion (such as the annular magnet). This may result in excessive attracting force between the magnetically conductive portion and the attracting portion for balancing the rotor. Further, the magnetically conductive sections adjacent to each other on the same member forming the magnetically conductive portion could be attracted by the north pole sections and the south pole sections on the rotor, leading to mutual interference between the magnetically conductive sections. The actual balancing effect of the magnetically conductive portion deteriorates.

To overcome the above problems, a plurality of short plate type magnetically conductive portions have been proposed to reduce the magnetic attracting balancing force for avoiding excessive effect on the rotational efficiency of the rotor. However, separate mounting of the magnetically conductive portions result in difficulty in precise alignment assembly.

### OBJECTS OF THE INVENTION

An object of the present invention is to provide a balancing structure for maintaining rotational balance for a rotor of a motor.

Another object of the present invention is to provide a balancing structure for providing an appropriate balancing effect while maintaining rotational balance for a rotor of a motor.

A further object of the present invention is to provide a simplified balancing structure allowing easy assembly while improving the actual balancing efficiency.

### SUMMARY OF THE INVENTION

A motor in accordance with the present invention comprises a fixed portion, a rotor, and a balancing plate. The fixed portion comprises a stator having at least one winding and at least one pole plate that extends to form a plurality of pole faces. The at least one winding is energizable to make the pole faces create alternating magnetic fields. The rotor includes an annular magnet facing the pole faces of the stator and a shaft rotatably extending through the fixed portion.

The balancing plate is mounted on the fixed portion and includes a connecting portion and at least two magnetically conductive faces that are integrally formed with the connecting portion as a single member and that face at least one face of the annular magnet. The at least two magnetically conductive faces are supported and connected by the connecting portion of the balancing plate. The at least two magnetically conductive faces and the annular magnet provide a magnetically attracting balancing effect for the rotor.

Preferably, the balancing plate further comprises at least two necks for respectively connecting the at least two magnetically conductive faces to the connecting portion. Preferably, each magnetically conductive face has a width greater than that of each neck.

Preferably, a notch is defined between a pair of the at least two magnetically conductive faces adjacent to each other. The notches and the at least two magnetically conductive faces face the annular magnet of the rotor.

The connecting portion is made of a magnetically conductive or non-conductive material, such as iron or plastic.

Preferably, the fixed portion further comprises a circuit board, and the balancing plate is in intimate contact with a top side or underside of the circuit board.

In an embodiment of the invention, the connecting portion is an outer connecting portion. Each neck extends radially inward from an inner periphery of the outer connecting portion. Each magnetically conductive face projects radially inward from an inner end of an associated neck, extends along a circumferential direction, and faces a bottom face of the annular magnet of the rotor.

Alternatively, the connecting portion is an outer connecting portion. Each neck extends radially inward from an inner periphery of the outer connecting portion. Each magnetically conductive face projects from an inner end of an associated neck along a longitudinal direction parallel to a longitudinal axis of the balancing plate, extends along the circumferential direction, and faces an inner periphery of the annular magnet of the rotor.

In another embodiment of the invention, the connecting portion is an inner connecting portion. Each neck extends radially outward from an outer periphery of the inner connecting portion. Each magnetically conductive face projects radially outward from an outer end of an associated neck, extends along a circumferential direction, and faces a bottom face of the annular magnet of the rotor. Preferably, the fixed portion comprises an axial tube, and the inner connecting portion comprises a central hole and mounted around the axial tube of the fixed portion.

Alternatively, the connecting portion is an inner connecting portion. Each neck extends radially outward from an outer periphery of the inner connecting portion. Each magnetically conductive face projects from an outer end of an associated neck along a longitudinal direction parallel to a longitudinal axis of the balancing plate, extends along the circumferential direction, and faces an inner periphery of the annular magnet of the rotor. Preferably, the fixed portion comprises an axial tube, and the inner connecting portion comprises a central hole and mounted around the axial tube of the fixed portion.

The stator may include radial winding or axial winding.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a first embodiment of a motor in accordance with the present invention;

FIG. 2 is a sectional view of the motor in FIG. 1;

FIG. 3 is an exploded perspective view of a second embodiment of the motor in accordance with the present invention;

FIG. 4 is a sectional view of the motor in FIG. 3;

FIG. 5 is an exploded perspective view of a third embodiment of the motor in accordance with the present invention; and

FIG. 6 is a sectional view of the motor in FIG. 5.

### DETAILED DESCRIPTION OF THE PREFERRED EMBODIMENTS

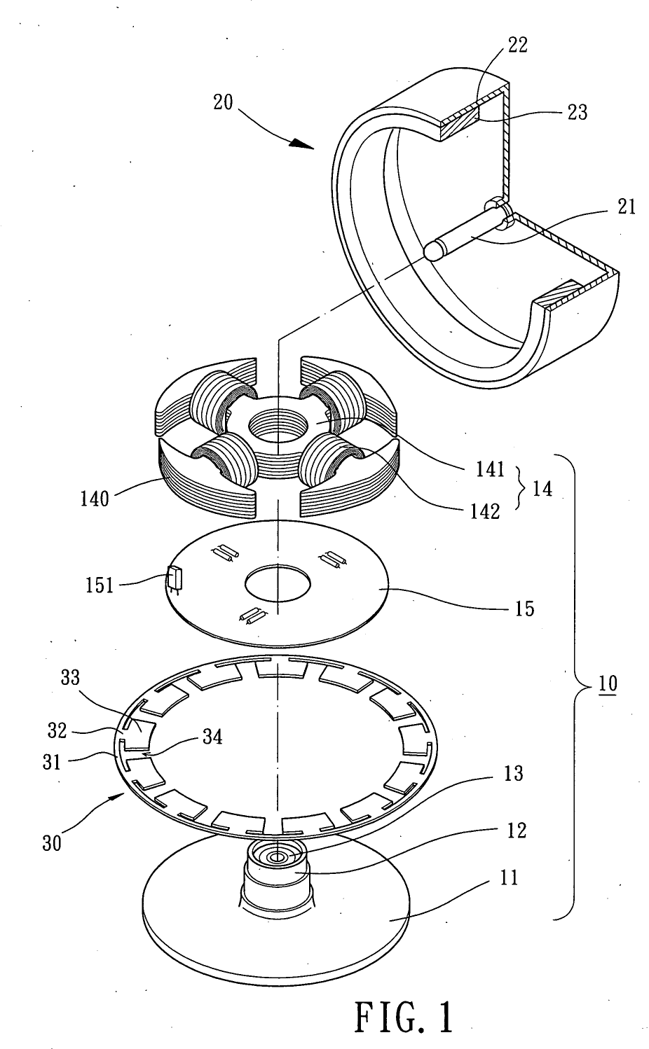

Referring to FIG. 1, a first embodiment of a motor in accordance with the present invention comprises a fixed portion 10, a rotor 20, and a balancing plate 30. The motor can be used as a motor for a heat-dissipating fan or a spindle motor for an optical disk drive, and particularly suitable for a miniature brushless D.C. motor.

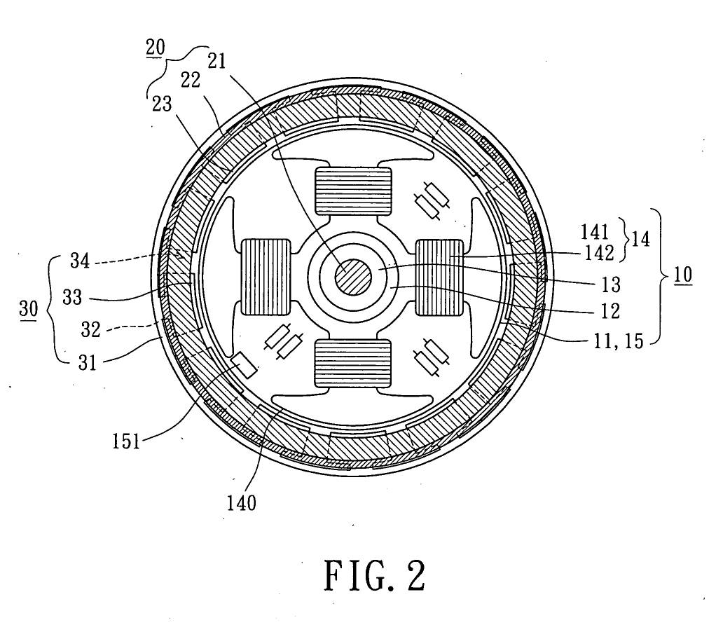

Referring to FIGS. 1 and 2, the fixed portion 10 includes a base 11, an axial tube 12, a bearing 13, a stator 14, and a circuit board 15. The base 11 may be coupled to a casing (not shown) of the motor. The axial tube 12 is fixed on or integrally formed with the base 11. At least one bearing 13 is mounted in the axial tube 12 whereas as the stator 14 and the circuit board 15 are mounted around the axial tube 12. The bearing 13 may be an oily bearing, ball bearing, fluid dynamic bearing, or magnetic bearing.

The stator 14 may be a stator with radial winding. In the illustrated embodiment, the stator 14 includes four pole plates 141 each having a winding 142 wound therearound along a radial direction. The pole plates 141 extend radially to form a plurality of pole faces 140.

At least one sensor 151 (such as a Hall element) is mounted on the circuit board 15 for detecting the rotational-status of the rotor 20, and the directions of the electric current of the windings 142 on the pole plates 141 are alternately controlled by a control circuit of the circuit board 15 such that alternating magnetic fields are created by the pole faces 140 of the pole plates 141.

Still referring to FIGS. 1 and 2, the rotor 20 includes a shaft 21, a housing 22, and an annular magnet 23. An end of the shaft 21 is fixed to a center of an end wall of the housing 22, with the other end of the shaft 21 rotatably extending through the bearing 13. The annular magnet 23 is mounted to an inner periphery of the housing 22. The annular magnet 23 includes a plurality of alternately disposed north pole sections (not shown) and south pole sections (not shown) on an inner periphery thereof, with the pole faces 140 of the stator 14 facing the north and south pole sections. Thus, the annular magnet 23 induces the alternate energizing of the pole faces 140 to drive the rotor 20 to turn.

The balancing plate 30 is substantially a ring-like plate and includes an outer connecting portion 31, at least two magnetically conductive faces 33, and a plurality of notches 34. The magnetically conductive faces 33 are connected with one another by the outer connecting portion 31. In the illustrated embodiment, the balancing plate 30 includes at least two necks 32 for respectively connecting the at least two magnetically conductive faces 33 with the outer connecting portion 31. The outer connecting portion 31, the necks 32, and the magnetically conductive faces 33 are integrally formed as a single member to simplify the structure and the assembling procedure.

The outer connecting portion 31 (and the necks 32, if appropriate) may be made of a magnetically conductive material such as iron or a magnetically non-conductive material such as plastic, depending on the product need. The magnetically conductive faces 33 are made of a magnetically conductive material such as iron.

In the illustrated embodiment, the necks 32 extend radially inward from an inner periphery of the outer connecting portion 31, and each magnetically conductive face 33 projects radially inward from an inner end of an associated neck 32 and extends along a circumferential direction. Alternatively, each magnetically conductive face 33 projects from the inner end of the associated neck 32 along a longitudinal direction parallel to a longitudinal axis of the balancing plate 30 and extends along the circumferential direction. Preferably, each magnetically conductive face 33 has a width greater than that of each neck 32. Each notch 34 is defined between a pair of the magnetically conductive faces 33 adjacent to each other.

The balancing plate 30 is securely mounted on the fixed portion 10 and may be in intimate contact with a top side, an underside, or an outer periphery of the circuit board 15. In assembly, the magnetically conductive faces 33 preferably face a bottom face or an inner periphery of the annular magnet 23 of the rotor 20.

After assembly, as illustrated in FIG. 2, the magnetically conductive faces 33 of the balancing plate 30 are fixed on the fixed portion 10 and face the bottom face of the annular magnet 23. When the rotor 20 turns, the annular magnet 23 attracts the magnetically conductive faces 33 to create a magnetically attracting balancing force for effectively avoiding shaking, vibration, and wobbling of the rotor 20, thereby maintaining rotational balance and rotational stability of the rotor 20.

Provision of the notches 34 between the magnetically conductive faces 33 avoids creation of excessive magnetically attracting balancing force and thus avoids excessive effect on the rotational efficiency of the rotor 30. Of more importance, the width of each magnetically conductive face 33 is greater than that of each neck 32, and the magnetically conductive faces 33 are connected with one another by the outer connecting portion 31 and the necks 32. Thus, even different polarities exist in each magnetically conductive face 33 as a result of facing different pole sections of the annular magnet 23, the possibility of mutual interference among the magnetically conductive faces 33 is lowered by the necks 32 and/or the outer connecting portion 31. The actual balancing efficiency of the magnetically conductive faces 33 is assured.

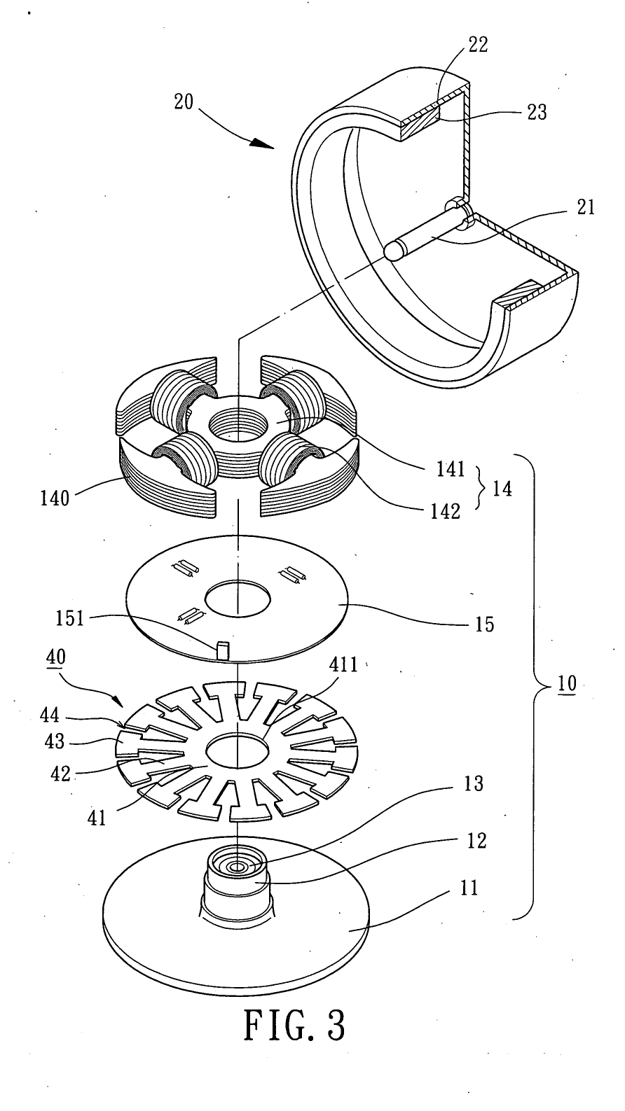

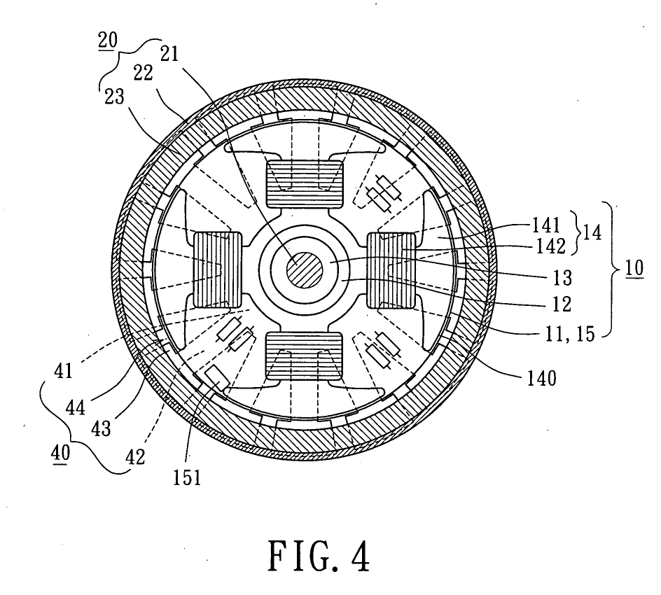

FIGS. 3 and 4 illustrate a second embodiment of the invention. In this embodiment, the balancing plate 40 includes an inner connecting portion 41, a plurality of magnetically conductive faces 43 connected by the inner connecting portion 41, and a plurality of notches 44. In the illustrated embodiment, the balancing plate 40 includes a plurality of necks 42 for respectively connecting the magnetically conductive faces 43 to the inner connecting portion 41. The inner connecting portion 41, the necks 42, and the magnetically conductive faces 43 are integrally formed as a single member to simplify the structure and the assembling procedure. The inner connecting portion 41 includes a central hole 411 so as to be mounted around the axial tube 12 of the fixed portion 10.

The inner connecting portion 41 (and the necks 42, if appropriate) may be made of a magnetically conductive material such as iron or a magnetically non-conductive material such as plastic, depending on the product need. The magnetically conductive faces 43 are made of a magnetically conductive material such as iron.

In the illustrated embodiment, the necks 42 extend radially outward from an outer periphery of the inner connecting portion 41, and each magnetically conductive face 43 projects radially outward from an outer end of an associated neck 42 and extends along a circumferential direction. Alternatively, each magnetically conductive face 43 projects from the outer end of the associated neck 42 along a longitudinal direction parallel to a longitudinal axis of the balancing plate 40 and extends along the circumferential direction. Preferably, each magnetically conductive face 43 has a width greater than that of each neck 42. Each notch 44 is defined between a pair of the magnetically conductive faces 43 adjacent to each other.

The balancing plate 40 is securely mounted on the fixed portion 10 and may be in intimate contact with a top side or an underside of the circuit board 15. In assembly, the magnetically conductive faces 43 preferably face a bottom face or an inner periphery of the annular magnet 23 of the rotor 20.

By such an arrangement, the balancing plate 40 also maintains rotational balance and rotational stability of the rotor 20. The possibility of mutual interference among the magnetically conductive faces 43 is lowered by the necks 42 and/or the outer connecting portion 41. The actual balancing efficiency of the magnetically conductive faces 43 is assured.

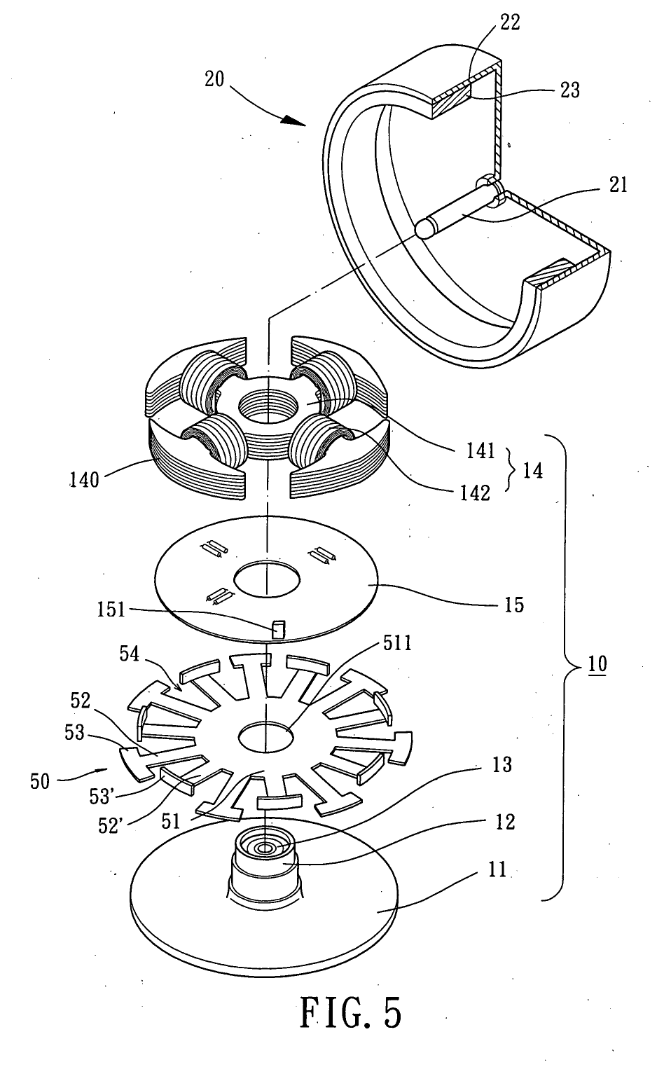

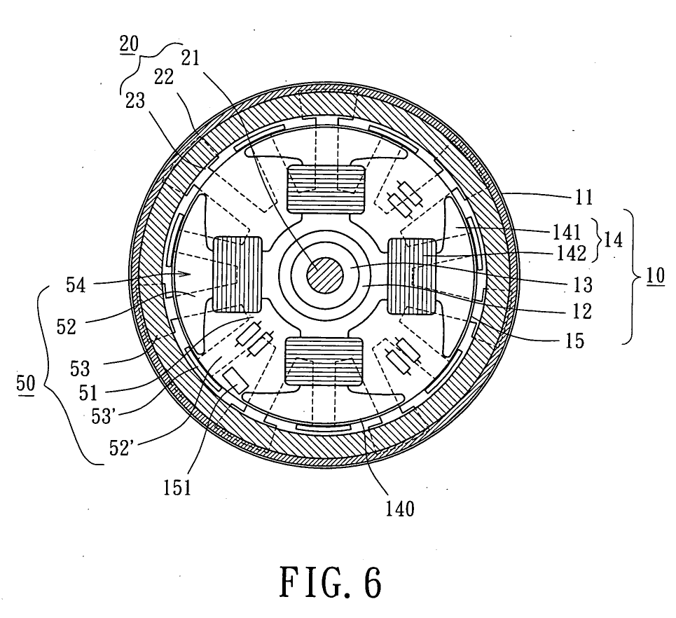

FIGS. 5 and 6 illustrate a third embodiment of the invention. In this embodiment, the balancing plate 50 includes an inner connecting portion 51, a plurality of magnetically conductive faces 53 and 53′ connected by the inner connecting portion 51, and a plurality of notches 54. In the illustrated embodiment, the balancing plate 50 includes a plurality of necks 52 and 52′ for respectively connecting the magnetically conductive faces 53 and 53′ to the inner connecting portion 51. The inner connecting portion 51, the necks 52 and 52′, and the magnetically conductive faces 53 and 53′ are integrally formed as a single member to simplify the structure and the assembling procedure. The inner connecting portion 51 includes a central hole 511 so as to be mounted around the axial tube 12 of the fixed portion 10.

The inner connecting portion 51 (and the necks 52 and 52′, if appropriate) may be made of a magnetically conductive material such as iron or a magnetically non-conductive material such as plastic, depending on the product need. The magnetically conductive faces 53 and 53′ are made of a magnetically conductive material such as iron.

In the illustrated embodiment, each neck 52, 52′ extends extend radially outward from an outer periphery of the inner connecting portion 51. Each magnetically conductive faces 53 projects radially outward from an outer end of an associated neck 52 and extends along a circumferential direction. Further, each magnetically conductive face 53′ projects from the outer end of the associated neck 52′ along a longitudinal direction parallel to a longitudinal axis of the balancing plate 50 and extends along the circumferential direction. Preferably, each magnetically conductive face 53, 53′ has a width greater than that of each neck 52, 52′. Each notch 54 is defined between a pair of the magnetically conductive faces 53 and 53′ adjacent to each other.

The balancing plate 50 is securely mounted on the fixed portion 10 and may be in intimate contact with a top side or an underside of the circuit board 15. In assembly, the magnetically conductive faces 53 face a bottom face of the annular magnet 23 of the rotor 20 whereas the magnetically conductive faces 53′ face an inner periphery of the annular magnet 23.

By such an arrangement, the balancing plate 50 also maintains rotational balance and rotational stability of the rotor 20. The possibility of mutual interference between the magnetically conductive faces 53 and 53′ is lowered by the necks 52 and 52′ and/or the outer connecting portion 51. The actual balancing efficiency of the magnetically conductive faces 53 and 53′ is assured.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A motor comprising:
a fixed portion including a stator, the stator including at least one winding and at least one pole plate that extends to form a plurality of pole faces, said at least one winding being energizable to make said pole faces create alternating magnetic fields;
a rotor including a shaft rotatably extending through the fixed portion and an annular magnet facing the pole faces of the stator; and
a balancing plate mounted on the fixed portion, the balancing plate including a connecting portion and at least two magnetically conductive faces that are integrally formed with the connecting portion as a single member and that face at least one face of the annular magnet;
said at least two magnetically conductive faces being supported and connected by the connecting portion of the balancing plate, said at least two magnetically conductive faces and the annular magnet providing a magnetically attracting balancing effect for the rotor.

2. The motor as claimed in claim 1, wherein the balancing plate further comprises at least two necks for respectively connecting said at least two magnetically conductive faces to the connecting portion.

3. The motor as claimed in claim 2, wherein each said magnetically conductive face has a width greater than that of each said neck.

4. The motor as claimed in claim 1, wherein a notch is defined between a pair of said at least two magnetically conductive faces adjacent to each other, and wherein the notches and said at least two magnetically conductive faces face the annular magnet of the rotor.

5. The motor as claimed in claim 1, wherein the connecting portion is made of a magnetically conductive material.

6. The motor as claimed in claim 1, wherein the connecting portion is made of a magnetically non-conductive material.

7. The motor as claimed in claim 1, wherein the fixed portion further comprises a circuit board having a top side, and wherein the balancing plate is in intimate contact with the top side of the circuit board.

8. The motor as claimed in claim 1, wherein the fixed portion further comprises a circuit board having an underside, and wherein the balancing plate is in intimate contact with the underside of the circuit board.

9. The motor as claimed in claim 2, wherein the connecting portion is an outer connecting portion having an inner periphery, each said neck extending radially inward from the inner periphery of the outer connecting portion, each said magnetically conductive face projecting radially inward from an inner end of an associated one of the necks, extending along a circumferential direction, and facing a bottom face of the annular magnet of the rotor.

10. The motor as claimed in claim 2, wherein the connecting portion is an outer connecting portion having an inner periphery, each said neck extending radially inward from the inner periphery of the outer connecting portion, each said magnetically conductive face projecting from an inner end of an associated one of the necks along a longitudinal direction parallel to a longitudinal axis of the balancing plate, extending along the circumferential direction, and facing an inner periphery of the annular magnet of the rotor.

11. The motor as claimed in claim 2, wherein the connecting portion is an inner connecting portion having an outer periphery, each said neck extending radially outward from the outer periphery of the inner connecting portion, each said magnetically conductive face projecting radially outward from an outer end of an associated one of the necks, extending along a circumferential direction, and facing a bottom face of the annular magnet of the rotor.

12. The motor as claimed in claim 11, wherein the fixed portion comprises an axial tube, and wherein the inner connecting portion comprises a central hole and mounted around the axial tube of the fixed portion.

13. The motor as claimed in claim 2, wherein the connecting portion is an inner connecting portion having an outer periphery, each said neck extending radially outward from the outer periphery of the inner connecting portion, each said magnetically conductive face projecting from an outer end of an associated one of the necks along a longitudinal direction parallel to a longitudinal axis of the balancing plate, extending along the circumferential direction, and facing an inner periphery of the annular magnet of the rotor.

14. The motor as claimed in claim 13, wherein the fixed portion comprises an axial tube, and wherein the inner connecting portion comprises a central hole and mounted around the axial tube of the fixed portion.

15. The motor as claimed in claim 1, wherein the stator comprises one of radial winding and axial winding.
